(19) United States
(12) Patent Application Publication
(10) Pub. No.: US 2007/0234765 A1
(43) Pub. Date: Oct. 11, 2007

(54) Combination lock structure

(76) Inventor: Cheng-Tao Tsai, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/397,698

(22) Filed: Apr. 5, 2006

(51) Int. Cl. E05B 37/02

(52) U.S. Cl. 70/30

(57) ABSTRACT

A combination lock includes a lock head, a pivotal seat pivotal to the head, and a cable including an insertion portion, and a stopping portion; the pivotal seat has a hole, and the cable is joined to the pivotal seat in a replaceable manner with the insertion portion being passed through the hole, and with the stopping portion being prevented from passing through the hole of the pivotal seat; the lock head has a tapering eccentric lock hole therefore when the lock is in the locking position with the cable insertion portion being fastened in the eccentric lock hole, the insertion portion can be moved further into the eccentric lock hole for reducing the loop size formed by the cable; the combination lock can be reset after toothed disks in dials are linearly displaced so as to disengage the dials by means of pressing a sliding member thereof.

### BACKGROUND OF THE INVENTION

1. Field of the Invention

The present invention relates to a combination lock, more particularly one, which can be rest, and is equipped with a cable capable of being replaced with another one of a different length; the cable can be moved so as to reduce the loop size formed thereby when the combination lock is in a locking position.

2. Brief Description of the Prior Art

Bicycles, motorcycles etc are usually locked with cable combination locks to prevent thievery. A common cable combination lock includes a lock head, and a cable; the cable is securely joined to the lock head at a fixed end, and has a free end; to lock an object, the cable is passed around a certain portion of the object, and the free end of the cable is fastened to the lock head.

However, such a cable combination lock is found to have the following disadvantages:

1. The cable combination lock can't be changed in length of its cable because the cable is securely joined to the lock head at the fixed end. Consequently, the cable can be too short to pass around large objects, and too long for small-sized objects, occupying too much space and wasting materials.

2. The cable combination lock will form a loop with a fixed circumference after the free end of the cable is fastened to the lock head therefore the circumference of the loop can't be adjusted according to the size of an object to be locked.

3. The cable combination lock can't be reset in its combination therefore the user isn't allowed to set the lock with a combination capable of being easily remembered by him/her.

### SUMMARY OF THE INVENTION

It is a main object of the invention to provide an improvement on a cable combination lock to overcome the above-mentioned problems.

The combination lock of the present invention includes a lock head, a pivotal seat pivotal to the head, and a cable including an insertion portion, and a stopping portion. The pivotal seat has a hole, and the cable is joined to the pivotal seat in a replaceable manner with the insertion portion being passed through the hole, and with the stopping portion being prevented from passing through the hole of the pivotal seat. The lock head has a tapering eccentric lock hole; thus, when the lock is in the locking position with the cable insertion portion fastened in the tapering eccentric lock hole, the cable insertion portion can be further moved into the tapering eccentric lock hole for reducing the loop size formed by the cable, allowing the cable to be tighter around an object locked with the lock. The combination lock can be reset after toothed disks in dials are linearly displaced so as to disengage the dials by means of pressing a sliding member thereof.

### BRIEF DESCRIPTION OF THE DRAWINGS

The present invention will be better understood by referring to the accompanying drawings, wherein:

FIG. 1 is an exploded perspective view of the lock of the invention,

FIG. 2 is a sectional view of the lock of the present invention,

FIG. 3 is a view of the combination lock of present invention under resetting action (1),

FIG. 4 is a view of the lock under resetting action (2),

FIG. 5 is a view of the lock under resetting action (3),

FIG. 6 is a view of the lock under resetting action (4),

FIG. 7 is a view of the lock under resetting action (5),

FIG. 8 is a view of the lock under resetting action (6), and

FIG. 9 is a view of the lock of the present invention in use.

### DETAILED DESCRIPTION OF THE PREFERRED EMBODIMENTS

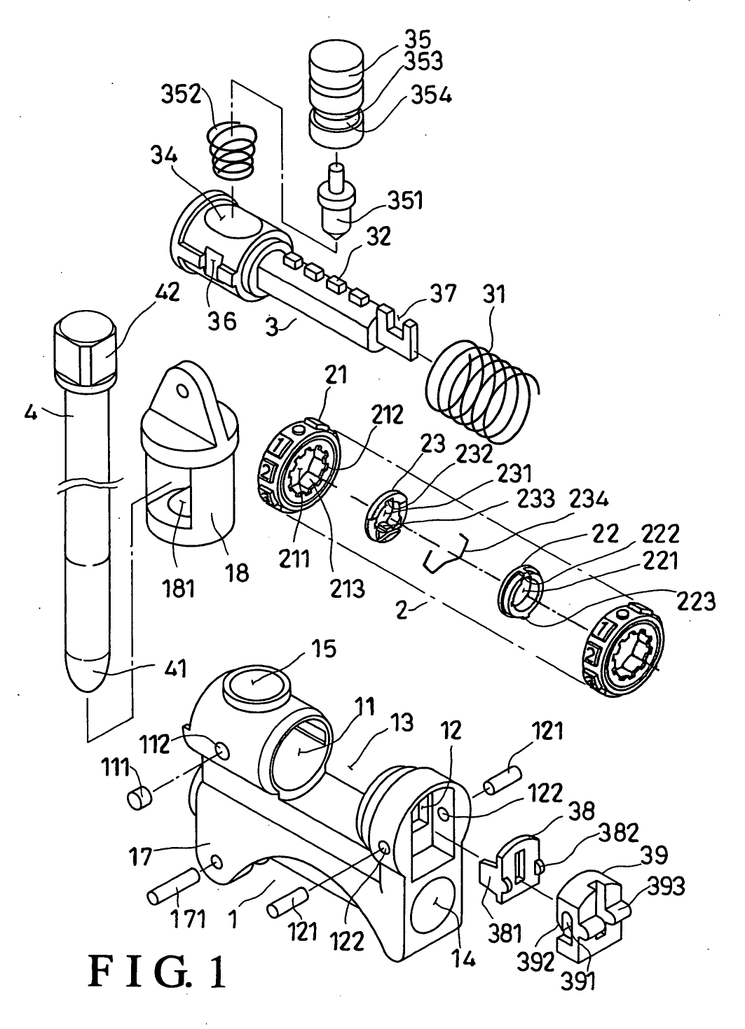

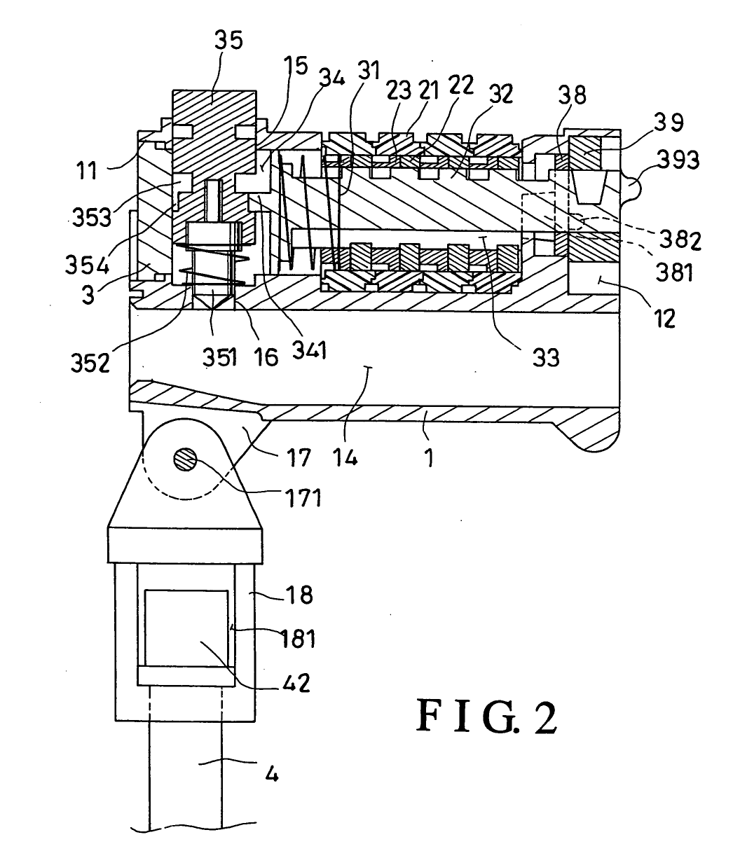

Referring to FIGS. 1 and 2, a preferred embodiment of a cable combination lock of the present invention includes a lock head 1, a dial set 2, a lock rod 3, and a cable 4.

The lock head 1 has a through hole 11 at a first end, a fitting hole 12 facing the through hole 11 at a second end, an open space 13 between the through hole 11 and the fitting hole 12, an eccentric lock hole 14, a receiving hole 15 above and communicating with the through hole 11, a through hole 16 under and communicating with the through hole 11 as well as aligned with the receiving hole 15, a fixing hole 112 beside and communicating with the through hole 11, rivet holes 122 beside and communicating with the fitting hole 12, a pivotal protrusion 17, and a pivotal seat 18, which has a hole 181, and is pivoted to the pivotal protrusion 17 by means of a pivotal shaft 171; the eccentric lock hole 14 has a section tapering towards an outer end; an engaging bar 111 is passed through the fixing hole 112 to stick into the through hole 11; rivets 121 are secured to the rivet holes 122.

The dial set 2 is held in the open space 13 between the through hole 11 and the fitting hole 12 of the lock head 1; each dial 21 of the dial set 2 has a through hole 211, several engaging gaps 212 around the through hole 211 on a circumferential side, several convexities and concavities 213 around the through hole 211 on a circumferential side, and both a toothed disk 22 and a position-keeping element 23 held in the through hole 211; the toothed disk 22 and the position-keeping element 23 touch each other, and have a through hole 221, and a through hole 231 respectively, which through holes 221 and 231 face each other; the toothed disk 22 has a recess 222 adjacent to the through hole 221 on an inner side thereof, and a protruding tooth 223 on an outer side for fitting in the engaging gaps 212; the position-keeping element 23 has both a recess 232 and a protruding tooth 233 adjacent to the through hole 231 on an inner circumferential side thereof, and an elastic element 234 fitted thereon and pressing the convexities and concavities 213.

The lock rod 3 is inserted through an elastic element 31, the through hole 11 of the lock head 1, the through holes 221 and 231 of the toothed disks 22 and the position-keeping elements 23 of the dial set 2, and sticks out through the fitting hole 12 of the lock head 1 such that the elastic element 31 presses an adjacent position-keeping element 23 of the dial set 2 at one end thereof; the lock rod 3 has several equidistantly spaced protrusions 32, and a guide groove 33, in which the protruding teeth 233 of the position-keeping elements 23 are held; the lock rod 3 has a recess 36 on a lateral side, a holding hole 34, and a stopping protrusion 341 inside the holding hole 34, which holding hole 34 is within the through hole 11 and faces the receiving hole 15 of the lock head 1.

The lock rod 3 has a locking member 35 inserted in the holding hole 34 thereof, and a pressing rod 351 is passed through an elastic element 352 and fitted to a lower end of the locking member 35 in a slightly movable manner to point at the through hole 16 of the lock head 1; the elastic element 352 touches an inner side of the lock head 1 and the pressing rod 351 at two ends thereof for biasing the pressing rod 351 away from the through hole 16 and further into the through hole 11 of the lock head 1; the locking member 35 has an upper annular recess 353, and a lower annular recess 354, and the stopping protrusion 341 of the lock rod 3 is usually pressed against the lower annular recess 354; the engaging bar 111 of the lock head 1 is held in the recess 36 of the lock bar 3 to prevent the lock bar 3 from falling off while the lock bar 3 is moved relative to the lock head 1.

The lock rod 3 further has a holding space 37 on a second end, which is adjacent to the fitting hole 12, and usually sticks out from the fitting hole 12; a pushing member 38, and a sliding member 39 are positioned around the second end of the lock rod 3; an inward side of the pushing member 38 has pushing protrusions 381 touching one of the toothed disks 21 of the dial set 2; an outward side of the pushing member 38 has guiding protrusions 382 touching the sliding member 39; the sliding member 39 has guide grooves 391, into which the rivets 121 of the lock head 1 is passed; the sliding member 39 has sloping guide rails 392 touching the pushing member 38; the sliding member 39 further has pressing portions 393 on an outer side thereof.

The cable 4 has an insertion portion 41 made of hard materials at a free end, and a stopping portion 42 at the other end; the cable 4 is passed through the hole 181 of the pivotal seat 18 of the lock head 1 from the insertion portion 41 thereof with the stopping portion 42 thereof being prevented from passing through the hole 181 by the pivotal seat 18.

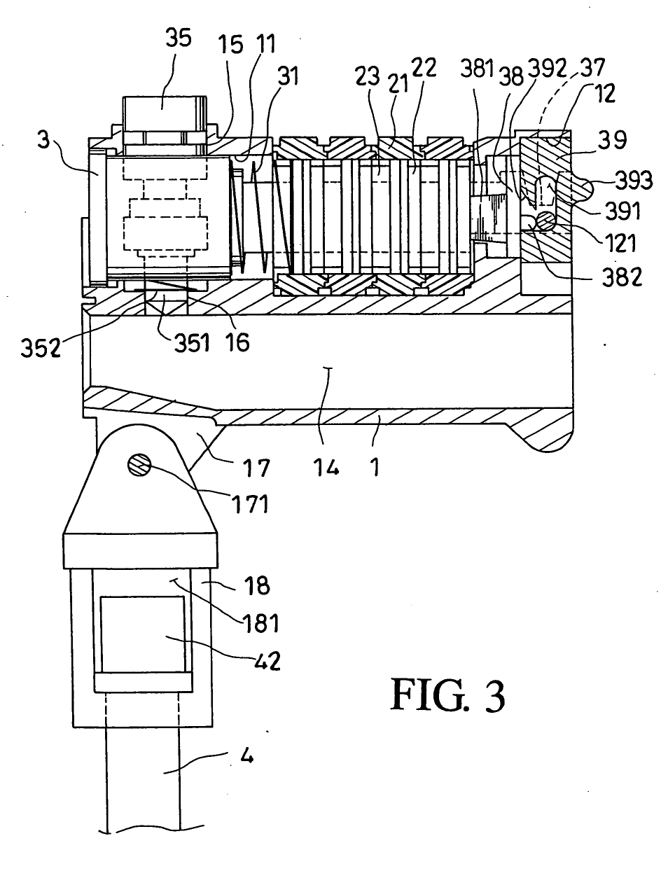

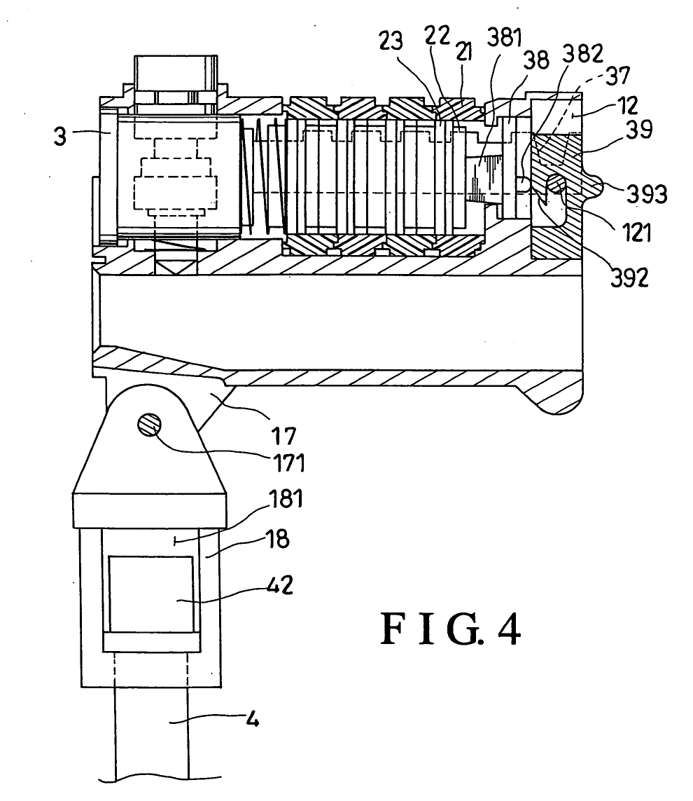

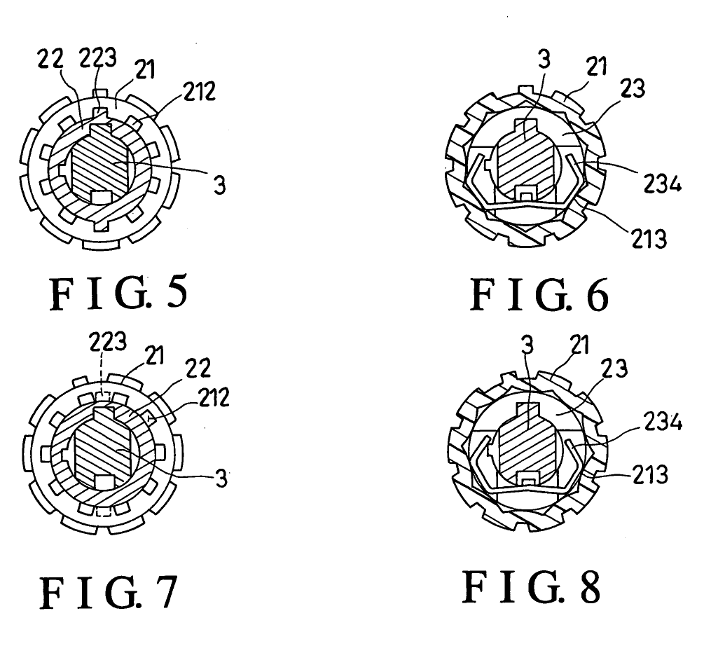

To set the combination lock, referring to FIGS. 3 to 8, first the combination lock is moved to the unlocking position, and the user exert force on the pressing portions 393 of the sliding member 39 such that the sliding member 39 is moved downwards into the holding space 37 of the lock rod 3; thus, the sloping guide rails 392 are pressed against and moved relative to the guiding protrusions 382 of the pushing member 38 so as to push the pushing member 38 inwardly, and in turn the pushing member 38 causes linear displacement of the toothed disks 22 and the position-keeping elements 23 for separating the protruding teeth 223 of the toothed disks 22 from the engaging gaps 212 of the dials 21. Next, the dials 21 are turned to their respective new positions to set the combination. Afterwards, the user exerts force on the pressing portions 393 of the sliding member 39 to move the sliding member 39 upwards; thus, the elastic element 31 pushes the lock rod 3 back to its original position, and it turn the protruding teeth 223 of the toothed disks 22 are held in the engaging gaps 212 of the dials 21.

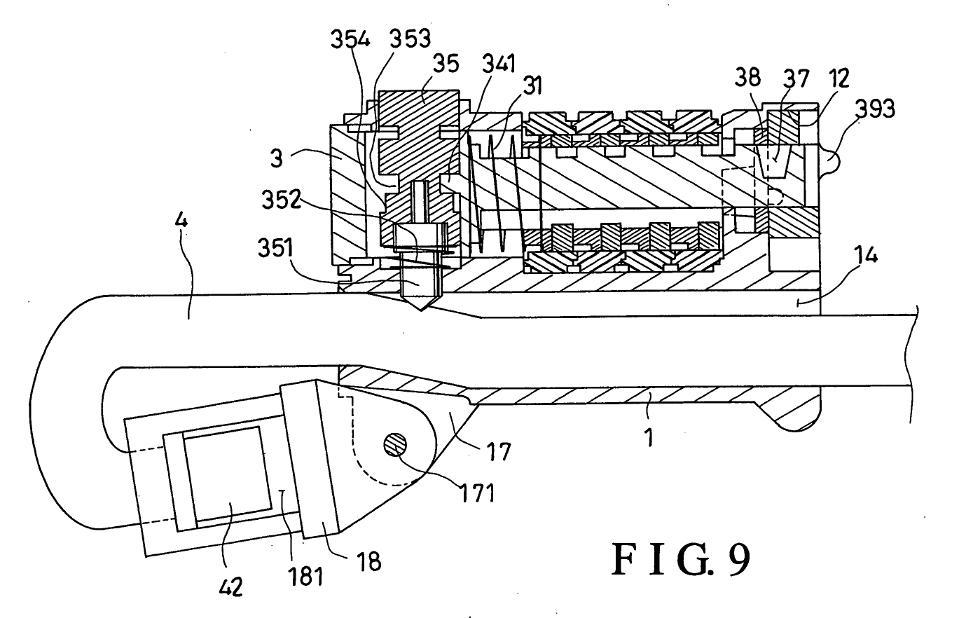

The cable 4 can be replaced with another one with a different length because the cable 4 is passed through the hole 181 of the pivotal seat 18 of the lock head 1 from the free insertion portion 41, and joined to the pivotal seat 18 with the stopping portion 42 being confined in the hole 181. To lock an object with the present cable combination lock, the cable 4 is passed through a portion of the object, and inserted in the eccentric lock hole 14 of the lock head 1 from the free insertion portion 41. Referring to FIG. 9, the locking member 35 is pressed downwards after the free insertion portion 41 of the cable 41 is inserted in the eccentric lock hole 14; thus, the stopping protrusion 341 snaps onto the upper annular recess 353 of the locking member 35 to hold the locking member 35 in position, and the pressing rod 35 is passed into the eccentric lock hole 14 through the through hole 16 and pressed against the cable 4 to prevent the cable 4 from moving out of the eccentric lock hole 14; the stopping protrusion 341 will cause linear displacement of the lock rod 3 for the second end of the lock rod 3 to retreat into the fitting hole 12 of the lock head 1 as soon as it snaps onto the upper annular recess 353 of the locking member 35, thus preventing the sliding member 39 from moving downwards. Consequently, the combination can't be reset. The insertion portion 41 of the cable 4 can't be drawn out of the lock hole 14 because the lock hole 14 is eccentric and tapers towards the outer end, and because the cable 4 is hard; because the pressing rod 351 of the locking member 35 is slightly movable, the insertion portion 41 of the cable 4 can be forced to move further into the eccentric lock hole 14 for making the cable 4 tighter around the locked object when the lock is in the locking position, but it is impossible to draw the insertion portion 41 completely out of the eccentric lock hole 14. Therefore, the cable combination lock will lock effectively.

Furthermore, to unlock the present combination lock, the dials 21 are turned to the unlocking position, in which position the recesses 222, 232 of the toothed disks 22 and the position-keeping elements 23 are aligned with the spaced protrusions 32 of the lock rod 3, and in turn the lock rod 3 can be linearly displaced relative to the dial set 2. Next, the lock rod 3 is pushed towards the second end of the lock head 1 having the through hole 12; thus, the elastic element 352 biases both the pressing rod 351 and the locking member 35 to an upper position, in which position the lower annular recess 354 of the locking member 35 receives the stopping protrusion 341 instead of the upper annular recess 353, and the pressing rod 351 retreats into the through hole 16 of the lock head 1. Consequently, the pressing rod 351 is on longer pressed against the insertion portion 41 of the cable 4, and the insertion portion 41 can be drawn out of the eccentric lock hole 14 of the lock head 1.

From the above description, it can be seen that the present invention has the following advantages over the prior art:

1. The cable can be replaced with another one with a different length according to the user's need because it joined to the pivotal seat pivoted to the lock head in a separable manner by means of passing the free insertion portion thereof through the hole of the pivotal seat and confining the stopping portion thereof in the hole of the pivotal seat.

2. The insertion portion of the cable can be moved further into the eccentric lock hole of the lock head after the pressing rod of the locking member is pressed against it. Therefore, after the lock locks an object, the loop formed by the cable can be changed in its circumference to be tighter around the object.

3. The combination of the lock can be reset after the sliding member is pressed to cause linear displacement of the toothed disks in order to disengage the protruding teeth of the toothed disks from the dials. Therefore, the lock can reduce the risk of thievery effectively.

What is claimed is:

1. An improvement on a combination lock structure, comprising
a lock head, the lock head having a through hole on one end, and a fitting hole facing the through hole on other end; the lock head having an open space between the through hole and the fitting hole thereof;
a dial set held in the open space of the lock head, the dial set including a plurality of dials, each of the dials having a through hole, and a plurality of engaging gaps around the through hole on a circumferential side thereof; each of the dials having a toothed disk and a position-keeping element held in the through thereof, which toothed disk and position-keeping element touch each other, and each have a through hole; the through holes of the toothed disks and the position-keeping elements facing each other; each of the toothed disks having a protruding tooth on an outer side for fitting in the engaging gaps of a corresponding dial; each of the position-keeping elements having both a recess and a protruding tooth adjacent to the through hole thereof on an inner circumferential side; and
a lock rod, the lock rod being inserted through an elastic element, the through hole of the lock head, the through holes of the toothed disks and the position-keeping elements of the dial set, and sticking out through the fitting hole of the lock head such that the elastic element is pressed against an adjacent position-keeping element of the dial set at one end thereof; the lock rod having a holding space on a tail end thereof, which is adjacent to the fitting hole of the lock head; a pushing member, and a sliding member being positioned around the tail end of the lock rod; an inward side of the pushing member having at least one pushing protrusion touching an adjacent one of the toothed disks of the dial set; an outward side of the pushing member having a plurality of guiding protrusions touching the sliding member; the sliding member having a plurality of sloping guide rails touching the guiding protrusions of the pushing member;
when the sliding member is pressed down and into the holding space of the lock rod, the sloping guide rails thereof being going to be pressed against and moved relative to the guiding protrusions of the pushing member so as to push the pushing member inwardly, thus linearly displacing the toothed disks and the position-keeping elements so as to separate the protruding teeth of the toothed disks from the engaging gaps of the dials as well as allowing the dials to be turned to respective new positions to reset a combination of the combination lock.

2. An improvement on a combination lock structure, comprising
a lock head, the lock head having a tapering eccentric lock hole, and a through hole communicating with the eccentric lock hole;
a lock rod inserted in the lock head, the lock head having a holding hole facing and communicating with the through hole of the lock head; the lock rod having a locking member held in the holding hole thereof; the locking member having a pressing rod fitted to a lower end thereof in a slightly movable manner; the pressing rod being held in the holding hole of the lock rod as well as pointing at the through hole of the lock head; and
a cable, the cable having an insertion portion at a free end thereof for insertion in the tapering eccentric lock hole of the lock head;
the combination lock being moved to a locking position by means of pressing the locking member with the pressing rod for the pressing rod to stick into the tapering eccentric lock hole through the through hole of the lock head; the pressing rod being going to be pressed against the insertion portion of the cable with the cable insertion portion being fastened to the lock head in a non-separable manner when the locking member with the pressing rod is pressed so as to move the combination lock to a locking position after the cable insertion portion has been inserted in the tapering eccentric lock hole; the cable being linearly displaceable further into the tapering eccentric lock hole after it is fastened to the lock head by means of the pressing rod.

3. An improvement on a combination lock structure, comprising
a combination lock head, the combination lock head having a pivotal protrusion; the combination lock head having a pivotal seat pivoted to the pivotal protrusion thereof by means of a pivotal shaft; the pivotal seat having a hole; and
a cable, the cable including an insertion portion at a free end, and a stopping portion at other end; the cable being joined to the pivotal seat with the insertion portion thereof being passed through the hole of the pivotal seat, and with the stopping portion thereof being prevented from passing through the hole of the pivotal seat by the pivotal seat.
